(19) United States
(12) Patent Application Publication
(10) Pub. No.: US 2007/0050914 A1
(43) Pub. Date: Mar. 8, 2007

(54) Discharge printing process of fibers dyed with indigo dye and/or sulfide dye

(75) Inventors: Yosuke Kitagawa, Shiga (JP); Kenzo Nishizono, Osaka (JP)

Correspondence Address: EDWARDS & ANGELL, LLP, P.O. BOX 55874, BOSTON, MA, 02205, US

(73) Assignee: Matsui Shikiso Chemical Co., Ltd., Kyoto (JP)

(21) Appl. No.: 11/445,831

(22) Filed: Jun. 1, 2006

(30) Foreign Application Priority Data
Sep. 7, 2005 (JP) 2005-259340

(51) Int. Cl. C11D 3/00

(52) U.S. Cl. 8/115.51

(57) ABSTRACT

The object of the invention is to provide a discharging agent for fibers dyed with an indigo dye and/or a sulfide dye, which enables stable discharge printing treatment to give the fibers soft texture, bright coloration and contours, which also enables printing. The object was achieved by the following: (1) A discharging agent for a fiber dyed with an indigo dye and/or a sulfide dye, consisting of chlorite and a viscosity-increasing nonionic surfactant, (2) a discharging agent according to the item (1), wherein the viscosity-increasing nonionic surfactant is a nonionic surfactant having HLB of 15 or higher, (3) a discharge printing process of a fabric or a sewing product dyed with an indigo dye and/or a sulfide dye, characterized in that a discharging agent having an adjusted pH of 7-12 and consisting of chlorite and a viscosity-increasing nonionic surfactant is printed on or applied to the fabric or the sewing product, followed by the application of a heat treatment, and (4) a discharge printing process according to the item (3), wherein the discharge printing treatment is performed simultaneously with, before, or after a coloring treatment.

### TECHNICAL FIELD

The invention relates to a discharge printing process of fibers dyed with an indigo dye and/or a sulfide dye.

### BACKGROUND ART

Cottons dyed with an indigo dye or a sulfide dye are mainly used in denim fabric, and jeans are known as sewing products of the denim fabric.

Denim fabric is produced as follows: as the warp, a cotton thread made by plying cotton fibers into a rope shape is used, and the thread is immersed in a bath added with an indigo dye or a sulfide dye, a reducing agent and an alkaline chemical, then is subjected to air oxidation and immersed in a bath containing an oxidizing agent such as sodium perborate; these processes are repeated so that the cotton thread is dyed by a rope-dyeing method in which it is dyed with colors such as blue, dark blue and black; then the dyed cotton thread is woven with an undyed plied cotton thread as the weft into denim fabric.

Meanwhile, dyeing using a reactive dye is recently carried out due to its easy process of dyeing. However, because the color shade, texture, and changes in colors over time in jeans died with indigo dyes are popular, dyeing of denim and jeans is mostly performed using indigo dyes.

As a discharging agent for denim fabric and others, active chlorine bleach such as hypochlorite, chlorite, bleaching powder, and cyanuric chloride bleach, as well as oxidative bleaching agents such as permanganate, hydrogen peroxide solution, sodium perborate, and barium peroxide, or reductive bleaching agents such as hydrosulfite are used.

A method of using active chlorine bleach includes, for example, (1) a method wherein a jean is immersed in hypochlorite solution, or a method wherein a pumice stone is impregnated with hypochlorite solution, which is then used in dry tumbling with a fabric product (patent reference 1), and (2) a method wherein sodium chlorite and alkali ammonium salts are viscosity-increased by a cellulose thickener such as dextrin and gum tragacanth to make a printing paste, which is used for discharge printing fabrics dyed with indigo dyes or sulfide dyes (patent reference 2).

However, according to the conventional method (1), denim or jeans are either subjected to discharging in their entirety, or to partial discharging based on craftworker's artistic sense, and the method is insufficient since this is not an industrial discharging process for a large amount of products with identical shapes.

Therefore, application of a printing process was considered; however, when printing using sodium hypochlorite and an alkaline chemical was attempted by means of a printing process, a pattern was not successfully produced using a screen stencil due to the low viscosity.

Accordingly, although as a method to increase viscosity, we attempted to use, for example, an organic thickener, this agent had poor compatibility with sodium hypochlorite and was unable to increase the viscosity due to heat generation or decomposition; therefore, it was difficult to make a printing paste. A method to increase viscosity by using an inorganic thickener such as bentonite is also considered. However, thixotropy of the viscosity is extremely high, leading to a problem that a pattern with clear contours cannot be produced in continuous printing because of difficulties in uniform coating due to non-uniform concentration of the paste.

Furthermore, even when sodium hypochlorite is prepared into a printing paste by the use of an inorganic thickener, it generates heat and decomposes upon contact with organic substances, resulting in a decreased discharging ability. Accordingly, in coloring using a colorant consisting of a pigment and a synthetic resin emulsion, undesirable effects may be produced, and thus the application of this printing paste to a color-discharge printing process is not suitable.

In addition, the conventional method (2) have a problem that the use of a large quantity of a water-soluble cellulose thickener as a thickener results in discharged fabric with hard texture due to inability of completely removing the cellulose thickener, even if it is rinsed with water after the discharge printing treatment, and that color-discharge printing with good color fastness cannot be achieved even when a pigment and a synthetic resin emulsion are blended.

Next, as a method using an oxidative bleaching agent, (3) a method of producing a decolorization pattern on a dyed fiber product characterized by decolorization contrast of the pattern, the pattern being obtained by a difference in the amount of water attachment in the moisture of the dyed fiber product exposed in an ozone atmosphere, is known (patent reference 3).

However, in the conventional method (3), the decolorization pattern with the decolorization contrast is produced on the entire fabric, which is different from making a completely decolorized pattern, thus, this is problematic.

In addition, as a method using a reductive bleaching agent, (4) a method of decolorizing dyed fiber products characterized in that dyed woven fabrics or their sewing products are decolorized by reduction using glucose having a reducing property is known (patent reference 4).

However, the conventional method (4) has a disadvantage that it lacks convenience since a process of removal of thickeners using an enzyme and a quantity-reducing process are required as pretreatment.
[Patent document 1] JP, A, 10-226957, lines 3-6, 2nd column, p 2.
[Patent document 2] JP, B, 28-145.
[Patent document 3] JP, B, 7-37715.
[Patent document 4] JP, A, 10-121387.

Under the above-mentioned circumstances, the development of a discharging agent for fibers dyed with an indigo dye and/or a sulfide dye, which enables stable discharging of the fibers to have soft textile, bright coloration and contours, as well as enables printing, is desired.

### DISCLOSURE OF THE INVENTION

Problem to be Solved by the Invention

The object of the invention is to provide a discharging agent for fibers dyed with an indigo dye and/or a sulfide dye, which enables stable discharging of the fibers to have soft textile, bright coloration and contours, as well as enables printing.

Means of Solving the Problem

Inventors of the invention devoted themselves to the research to solve the above problem, and found that a composition consisting of a specific active chlorine bleach and a specific thickener has a superior discharging property for fibers dyed with an indigo dye and/or a sulfide dye, and they completed this invention after further research.

The present invention consists of individual inventions that satisfy the following constituent features.
1. A discharging agent for a fiber dyed with an indigo dye and/or a sulfide dye, consisting of chlorite and a viscosity-increasing nonionic surfactant.
2. A discharging agent according to the above item 1, wherein the viscosity-increasing nonionic surfactant is a nonionic surfactant having HLB of 15 or higher.
3. A discharging agent according to the above item 1, wherein the discharging agent contains a wetting agent.
4. A discharging agent according to the above item 1, wherein the fiber is a fabric or a sewing product.
5. A discharge printing process, wherein when a fabric or a sewing product dyed with an indigo dye and/or a sulfide dye is subjected to a discharge printing treatment, a discharging agent having an adjusted pH of 7-12 and consisting of chlorite and a viscosity-increasing non ionic surfactant is printed on or applied to the fabric or the sewing product, followed by the application of a heat treatment.
6. A discharge printing process according to the above item 5, wherein the discharge printing treatment is performed simultaneously with, before, or after a coloring treatment.
7. A discharge printing process according to the above item 6, wherein the coloring treatment is performed using a colorant consisting of a pigment and a synthetic resin emulsion.
8. A discharge printing process according to the above item 5, wherein the discharge printing treatment is to conduct rinsing with water and dechlorination after the discharge printing treatment.
9. A fabric or a sewing product dyed with an indigo dye and/or a sulfide dye, patterned by the discharge printing process according to the above item 5.

The characteristic of the invention is that a discharging agent consisting of chlorite and a viscosity-increasing nonionic surfactant has been developed.

The discharging agent of the invention, when applied to fibers dyed with an indigo dye and/or a sulfide dye, enables stable discharging with bright coloration and contours, and provides soft texture of the dyed fabric obtained; in addition, it also enables printing; accordingly, the present invention is innovative in that it is advantageous in production processes, and that it enables color-discharge printing in combination with a coloring treatment.

The invention has been realized based on the following findings.
(a) As a discharging agent for dyed fabrics, active chlorine bleach, oxidative bleaching agents and reductive bleaching agents, etc. are used; for fabrics dyed with an indigo dye and/or a sulfide dye, active chlorine bleach is usually used.

However, as mentioned above, the method using active chlorine bleach has the following problems.

(Sodium-Hypochlorite Method)

Since a method of co-using sodium hypochlorite and alkali is inappropriate for a printing process due to low viscosity, there is a method in which a printing paste is made by the addition of an inorganic thickener. However, the paste is not applicable to continuous printing due to its extremely high thixotropy of the viscosity. In addition, when a coloring treatment using a colorant consisting of a pigment and a synthetic resin emulsion is co-applied, the sodium hypochlorite generates heat and decomposes upon contacting with organic substances, resulting in a decrease in the discharging ability, thus, it cannot be applied to color-discharge printing processes, which is disadvantageous.

(Sodium-Chlorite Method)

There is a discharge printing process where in sodium chlorite and alkali ammonium salts are viscosity-increased by a cellulose thickener such as dextrin and gum tragacanth to be used as a printing paste; however, the process is disadvantageous in that the use of a large quantity of water-soluble cellulose thickener results in a discharged fabric with hard texture due to inability to completely remove the cellulose thickener, even if it is rinsed with water after the discharge printing treatment, and that when a coloring treatment with a colorant consisting of a pigment and a synthetic resin emulsion is co-applied, the color-discharge printing process with good color fastness cannot be realized.
(b) Under such circumstances, as a result of accumulated research, the inventors used a viscosity-increasing nonionic surfactant as the thickener in the process of discharge printing of fibers dyed with an indigo dye and/or sulfide dye wherein chlorite was used as a discharging ingredient of the discharging agent, and found that the viscosity of the discharging agent obtained was increased and coating as well as printing treatments were enabled by the discharging agent; furthermore, the inventors also found that the discharging agent could be advantageously used in a color-discharge printing process upon co-application of a coloring treatment, because the agent did not have undesirable effects on the coloring ingredients; and thus the inventors completed this invention.
(c) When the discharging agent of the invention is used, patterns obtained have bright coloration and contours, as well as superior washing fastness and rubbing fastness.

The reason why the discharging agent of the invention exhibits superior properties is presumably that the following points act complexly: the nonionic surfactant as a viscosity-increasing ingredient is compatible with the chlorite as a discharging ingredient; the viscosity characteristic of the surfactant enables printing; and co-application of discharge printing treatment and coloring treatment is possible because the chlorite is not decomposed by a pigment that is used as a coloring ingredient.

The discharging agent of the invention enables printing of fibers dyed with an indigo dye and/or a sulfide dye, as well as color-discharge printing in combination with a coloring treatment; accordingly, the discharging agent of the invention shows particularly superior effects in terms of that it is advantageous in production, it can easily make bright and complex color patterns on dyed fabrics, and the patterns obtained show superior washing fastness and rubbing fastness, with soft texture of the dyed fabric.

In the following, the present invention is explained in further detail.

The discharging agent of the invention consists of chlorite and a viscosity-increasing nonionic surfactant, and it has the following characteristics: the discharging agent is optimal for discharging fibers dyed with an indigo dye and/or a sulfide dye; the discharge printing process according to the invention is carried out by printing or coating fibers with the present discharging agent, then by applying a heat treatment; and the discharge printing treatment of the invention enables a color-discharge printing process in combination with a coloring treatment.

The constituent features of the characteristics of the invention, i.e., (1) dyed fabric, (2) discharging agent, (3) discharge printing process, (4) color-discharge printing process, are specifically explained.

(1) Dyed Fabric

The discharging agent of the invention is optimal for fabrics or sewing products dyed with an indigo dye and/or sulfide dye.

The fabrics or sewing products dyed with an indigo dye and/or sulfide dye include denim fabric, jeans and the like.

(2) Discharging Agent

The discharging agent of the invention is characterized in that it consists of chlorite and a viscosity-increasing nonionic surfactant.

1) Chlorite

In the discharging agent of the invention, the use of chlorite as a discharging ingredient is requisite.

Chlorite includes, but not necessarily limited to, its sodium salts and potassium salts.

Since the chlorite of the invention has compatibility with the viscosity-increasing nonionic surfactant which is a viscosity-increasing ingredient, it exhibits a superior characteristic in discharge printing together with the surfactant.

In addition, in color-discharge printing wherein a pigment and synthetic resin emulsion are blended with the chlorite, it has a characteristic of enabling stable increase of viscosity as well as printing.

2) Viscosity-Increasing Nonionic Surfactant

As a viscosity-increasing ingredient in the discharging agent for printing of the invention, the use of a viscosity-increasing nonionic surfactant is requisite.

The viscosity-increasing nonionic surfactant of the invention has compatibility with chlorite as a discharging ingredient, and further couple with the improvement of the viscosity of said surfactant, it exhibits superior characteristics of efficiently discharge-printing fabrics or sewing products dyed with an indigo dye and/or sulfide dye without decreasing the soft texture of the treated fabric after the discharge printing treatment.

As a viscosity-increasing nonionic surfactant of the invention, the use of nonionic surfactants having HLB of 15 or higher is preferred.

Examples include the following surfactants in which HLB is adjusted to be 15 or higher, but not necessarily limited thereto: polyoxyethylene lauryl ether, polyoxyethylene cetyl ether, polyoxyethylene isocetyl ether, polyoxyethylene stearyl ether, polyoxyethylene isostearyl ether, polyoxyethylene higher alcohol ether, polyoxyethylene octyl phenyl ether, polyoxyethylene nonyl phenyl ether, polyoxyethylene styrenated phenyl ether, polyoxyethylene polyoxypropylene decyl ether, polyoxyethylene behenyl ether, polyoxyethylene cholesteryl ether, polyoxyethylene coconut oil fatty acid sorbitan, polyoxyethylene hardenedcasteroil, polyoxyethylene oleyl ether, polyoxyethylene glyceryl isostearate, polyoxyethylene glycerin monostearate, polyoxyethylene sorbitan monooleate, polyethylene glycol monostearate, polyoxyethyleneglycerylisostearatepyroglutamate, polyurethane denatured polyether, polyester denatured polyether, etc.

It is preferred that one or more of the above-mentioned viscosity-increasing ingredients are blended, wherein the viscosity is adjusted to be appropriate for a printing paste, i.e., between 500 and 200,000 mPa·s, preferably between 2,000 and 100,000 mPa·s, to be used as a discharging agent for printing.

Furthermore, when making a printing paste, other agents such as a surfactant with HLB of 15 or less, an emulsion containing mineral spirit, a cellulose thickener, and an acrylic acid thickener can be added and used, in addition to the above-mentioned viscosity-increasing ingredients.

3) Wetting Agent

When a wetting agent is added to the discharging agent of the invention, due to its retention of water, more effective discharge printing of fibers dyed with an indigo dye and/or a sulfide dye can be achieved during a dry heat treatment.

In addition, as another effect of the wetting agent, it can prevent embrittlement of fibers discharged by chlorite; blending of a wetting agent is preferred particularly in discharging thin fibers.

As a wetting agent, urea is most effective, but not necessarily limited thereto; for example, glycerin, ethylene glycol, propylene glycol, polypropylene glycol, hyaluronic acid, biuret and others may also be used.

The amount of a wetting agent blended is from 1 to 20%, preferably from 2 to 10%.

(3) Discharge Printing Process

The discharge printing process of the invention can be carried out by printing or coating a fabric or a sewing product dyed with an indigo dye and/or sulfide dye with a discharging agent consisting of chlorite and a viscosity-increasing nonionic surfactant, then by performing a discharge printing treatment by means of application of a heat treatment such as dry heat treatment or wet heat treatment.

Upon performing the discharge printing process of the invention, following points should be noted.

1) Adjustment of the Discharging Agent

The pH of the discharging agent should be adjusted between 7 and 12 for use.

When the pH is 6 or lower, chlorite decomposes and chlorine dioxide gas generates, and stability deteriorates; in addition, a printing paste suitable for printing cannot be obtained and effective discharge printing treatment cannot be achieved.

On the other hand, when the pH is 13 or higher, the viscosity-increasing ingredient is gelled and the viscosity cannot be maintained appropriately, which is not preferred.

As a pH adjuster, any alkaline agents may be used, which include alkali hydroxide, alkali sodium salt, alkali potassium salt, alkali phosphate, alkali organic acid, alkali ammonium salt, ammonium water, triethanol amine, diethanol amine, etc., but not necessarily limited thereto.

2) Printing

The printing step in the discharge printing treatment of the invention can be carried out using a screen stencil of 30-200 mesh made of polyester, nylon, or stainless gauze, prepared with any pattern, by printing the discharging agent on the fiber by means of a rubber or metal squeegee.

Machines used for printing include automatic screen printers, rotary screen printers, and hand screens. As another methods of printing, a roller printer using a knurling stencil which is engraved with an interval of 30-120 lines/inch and a depth of 50-150 μm may also be used.

3) Coating

Coating can be carried out by applying a viscosity-adjusted discharging agent to a fiber, by means of a method such as coating, brush strokes, brush painting or spray painting.

4) Heat Treatment

The heat treatment after printing of the invention may be carried out by dry heat treatment or wet heat treatment.

In the dry heat treatment, a general method, for example, baking can be adopted.

In the wet heat treatment, a general method, for example, atmospheric-pressure steaming, high-pressure steaming (HP steaming), high-temperature atmospheric-pressure steaming (HT steaming), or a method using a steam press in which atmospheric-pressure steaming and dry heat pressing are integrated can be used.

The heat treatment may be performed immediately after printing or coating, or following drying at a temperature from normal temperature to 160° C.

(4) Color-Discharge Printing Process

The discharge printing treatment of the invention has a characteristic that the coloring treatment can be performed simultaneously with, or before/after the discharge printing treatment; namely, color-discharge printing can be performed easily.

By the color-discharge printing of the invention, dyed fabrics with complex color pattern having soft texture, bright coloration and contours, as well as superior color fastness can be easily obtained.

In the coloring treatment of the color-discharge printing of the invention, general colorants, such as those consisting of a pigment and a fixing agent, may be used.

<Pigment>

A pigment for coloring is not particularly limited, so long as it is stable to chlorite.

Examples of a pigment include inorganic pigments such as titanium oxide, colcothar, ultramarine blue, iron oxide and carbon black pigments; and organic pigments such as azo pigments, phthalocyanine pigments, chromophthalo pigments, diketo pyrrole pigments, quinacridone pigments and dioxazine pigments; or pearl pigments, aluminum powder, luminous pigments, glitter, thermosensitive dye (microcapsule), and photosensitive dye (microcapsule), etc.

In addition, as a body pigment, silica, aluminum hydroxide, calcium carbonate, alumina, talc and clay may be added.

<Fixing Agent>

As a fixing agent to fix a coloring pigment, preferably those which have superior compatibility with chlorite and superior washing fastness after discharge printing treatment are used.

Examples include (meth)acrylate ester resin emulsions, urethane resin emulsions, ethylene-vinyl acetate resin emulsions.

Among the above-mentioned resin emulsions, (meth) acrylate ester resin emulsions include homopolymers or copolymers of methyl (meth)acrylate, ethyl (meth)acrylate, butyl (meth)acrylate, and 2-ethyl hexyl (meth)acrylate; copolymers of these with stylene, acrylonitrile, acrylic acid, itaconic acid, etc. can also be used, but not necessarily limited thereto, and those in which various functional groups are added, and those having different lengths of alkyl groups may also be used.

As for the urethane resin emulsions, any urethane resin emulsions including ether , ester , and carbonate urethane resin emulsions may be used.

In each of the above-mentioned resin emulsions, a synthetic resin emulsion such as vinyl chloride resin, vinyl acetate resin, epoxy resin, polyvinyl alcohol, and butyral resin may be blended.

In addition, as a curing agent, isocyanate compounds, block isocyanate compounds, epoxy resin curing agents, polyethylene imine, methylol melamine, methylated methylol melamine, ethylene imine, oxazoline curing agents, and carbodiimide may be added.

(5) Post-Treatment

After the above-mentioned heat treatment, the discharged fabric or sewing product is preferably subjected to rinse with water and dechlorination by a reductive agent.

When rinse with water and dechlorination are not applied, because active chlorine having oxidative ability remains on the discharged fabric, the pigment may be destroyed over time and the fiber may be embrittled.

As a reductive agent for dechlorination, sodium thiosulfate, sulfite salt, rongalite, decrolin, and hydrosulfite may be used; considering the problem of odor after the treatment, the use of sodium thiosulfate is preferred.

After the discharged fabric is rinsed with water and dried, dechlorination is preferably performed by dipping the fabric in a solution of 0.1-2% reductive agent, at a temperature from room temperature to 40° C. or lower, for 1-10 min.

Furthermore, after the discharged fabric is rinsed with water and dried, baking the fabric at 120° C.-150° C. for 1-5 min will provide discharged fabrics with superior color fastness.

(6) Others

In the discharging agent of the invention, auxiliary agents such as antioxidants, ultraviolet absorbers, penetrating agents, antiseptics, fungicides and metal chelate inhibitors may be optionally blended.

### EFFECTS OF THE INVENTION

The discharging agent of the invention is superior in that it enables stable discharge printing of a fabric or a sewing product dyed with an indigo dye and/or a sulfide dye, providing the discharged fabric with soft texture, bright coloration and contours, as well as superior color fastness.

The discharging agent of the invention also enables printing, thus the present invention is superior in that it easily provides a dyed fabric with complex color pattern by performing a coloring treatment simultaneously with, or before or after the discharge printing treatment.

### EMBODIMENTS FOR CARRYING OUT THE INVENTION

In the following, the invention is illustrated in further detail with reference to examples; however, the invention should not be limited to these examples. In the examples, “parts” and “%” indicate “parts by weight” and “weight %”, respectively, unless otherwise specified.

### EXAMPLE 1

A blue denim dyed with an indigo dye was automatic-screen printed using a 100-mesh polka-dot pattern screen stencil and a discharge-printing agent having a viscosity of 8,000 mPa·s and an adjusted pH of 9.5, which consists of 10 parts of sodium chlorite as a discharging ingredient, 7 parts of nonionic surfactant with HLB of 18 (EMACOL R-620: Matsui Shikiso Chemical Co., Ltd.) as a viscosity-increasing ingredient and 83 parts of water, to give a printed fabric.

Then the resulting printed fabric was dried at 100° C. for 1 min, and subjected to a printing treatment by wet heat treatment using high-temperature atmospheric-pressure steam (HT steam) at 140° C. for 5 min; the fabric was then rinsed with water and dipped in 1% sodium thiosulfate solution for 2 min for dechlorination, to give a discharge-printed fabric.

The obtained discharge-printed denim had a discharge pattern of white polka dots on blue background with soft texture, bright coloration and contours.

### EXAMPLE 2

A dark blue denim dyed with an indigo dye was hand-screen printed using a 80-mesh polka-dot pattern screen stencil and a color-discharge printing agent having a viscosity of 25,000 mPa·s and an adjusted pH of 9.0, which consists of 12 parts of sodium chlorite as a discharging ingredient, 4 parts of nonionic surfactant with HLB of 20 (VS 16H-2: Hokko Chemical Co., Ltd.) as a viscosity-increasing ingredient, 10 parts of urea as a wetting agent, 20 parts of terpene emulsion (Extender OS: Matsui Shikiso Chemical Co., Ltd.), 5 parts of azo pigment dispersing solution (MATSUMIN Neo Color Red MFB: Matsui Shikiso Chemical Co., Ltd.), 25 parts of acrylic acid ester resin emulsion (NIKASOL FX679: Nippon Carbide Industries, Co., Inc.) and 24 parts of water, to give a printed fabric.

Then the resulting printed fabric was dried at 100° C. for 1 min, and subjected to a discharge printing treatment by dry heat baking at 160° C. for 3 min; the fabric was then rinsed with water and dipped in 1% sodium thiosulfate solution for 2 min for dechlorination.

The obtained color-discharge printed denim had a red discharge-printing pattern on blue background with soft texture, bright coloration and contours. Furthermore, no decrease in the strength of the denim fiber was observed.

Additionally, the obtained color-discharge printed denim showed superior color fastness after 30 times of washing tests in accordance with JIS L-0217 103, and also superior color fastness after dry/wet rubbing tests in accordance with JIS L-0849.

Next, the obtained color-discharge printed denim was subjected to sewing, to give a jean with a pattern of red polka dots on blue background.

### EXAMPLE 3

The thigh parts of a jean dyed with an indigo dye and a sulfide dye were printed with a 2-color panda pattern, using a 80-mesh screen stencil and a yellow binder consisting of 95 parts of acrylic resin printing binder (MATSUMIN Binder 1155: Matsui Shikiso Chemical Co., Ltd.) and 5 parts of azo pigment dispersing solution (MATSUMIN Neo Color Yellow M3G: Matsui Shikiso Chemical Co., Ltd.) as well as 100 parts of a white binder for printing (MATSUMIN Super White Binder W-0116: Matsui Shikiso Chemical Co., Ltd.) as a white binder, to give a color-printed fabric.

Then, the entire panda pattern of the obtained color-printed fabric was over-printed using a 100-mesh screen stencil and a discharge-printing agent having a viscosity of 10,000 mPa·s and an adjusted pH of 9.5, which consists of 10 parts of sodium chlorite as a discharging ingredient, 8 parts of nonionic surfactant with HLB of 18 (SN Thickener 603: San Nopco Limited) as a viscosity-increasing ingredient, 10 parts of urea as a wetting agent and 72 parts of water, to give a printed fabric.

The obtained printed fabric was subjected to a discharge printing treatment by heat treatment at 150° C. for 30 s while applying steam using a steam press.

Then the fabric treated was rinsed with water, dipped in 2% sodium thiosulfate solution for 3 min for dechlorination, and dried to give a color-discharge printed fabric.

The obtained color-discharge printed blue jean had a white-and-yellow panda pattern at its thigh parts, with soft texture and bright coloration and contours.

Similar to Example 2, the jean obtained also had superior washing fastness and rubbing fastness.

### EXAMPLE 4

A black denim dyed with a sulfide dye was hand-screen printed using a 80-mesh polka-dot pattern screen stencil and a color-discharge printing agent having a viscosity of 7,000 mPa·s and an adjusted pH of 10.0, which consists of 10 parts of sodium chlorite as a discharging ingredient, 4 parts of nonionic surfactant with HLB of 18 (EMACOL R-620: Matsui Shikiso Chemical Co., Ltd.) as a viscosity-increasing ingredient, 10 parts of urea as a wetting agent, 5 parts of 15% guar gum (MEYPRO Gum NP: Meyhall Chemical AG), 10 parts of titanium-oxide-pigment dispersing solution (MATSUMIN Super White R-2: Matsui Shikiso Chemical Co., Ltd.), 25 parts of urethane resin emulsion (HYDRAN HW970: Dainippon Ink and Chemicals, Incorporated) and 36 parts of water, to give a printed fabric.

Then the resulting printed fabric was dried at 100° C. for 1 min, and subjected to a discharge printing treatment by dry heat baking at 160° C. for 3 min; the fabric was then rinsed with water and dipped in 1% sodium thiosulfate solution for 2 min for dechlorination, to give a color-discharge printed fabric.

The obtained color-discharge printed denim had a discharge printing pattern of white polka dots on blue background, with soft texture, bright coloration and contours. In addition, no decrease in the strength of the denim fiber was observed.

Similar to Example 2, the denim also had superior washing fastness and rubbing fastness.

### EXAMPLE 5

A discharge printing treatment was performed in accordance with Example 2, except that the urea of the discharging agent used in Example 2 was replaced with water.

As a result, the obtained discharge printing pattern showed a slight inferior discharging characteristic, and the red color of the polka-dot pattern on the blue denim looked slightly dirty, compared to Example 2.

Furthermore, tearing of the discharged parts showed that the strength of the denim fiber was slightly decreased in comparison to the original denim fiber.

### COMPARATIVE EXAMPLE 1

On a denim fabric dyed with an indigo dye, a polka-dot pattern was painted by a brush using a solution containing 20 parts of sodium hypocholorite (12% effective chlorine) and 2 parts of sodium hydroxide, and the fabric was heat-treated with HT steam at 140° C. for 5 min.

As a result, different from the polka-dot pattern obtained in Example 1, only an inhomogenous polka-dot pattern was obtained, and the pattern showed inferior discharging effect that the discharge printing pattern was not white.

### COMPARATIVE EXAMPLE 2

A discharge printing treatment was performed in accordance with Example 1, except that the sodium chlorite in Example 1 was replaced with sodium hypocholorite (12% effective chlorine) with an amount of blending of 40%.

As a result, heat generated in the process of blending the sodium hypocholorite, and the viscosity of the printing paste decreased from its appropriate value.

Furthermore, the obtained fabric showed inferior discharging characteristic, with only slight discharge of the blue color of the indigo dye.

### COMPARATIVE EXAMPLE 3

A denim dyed with an indigo dye was auto-screen printed using a 100-mesh polka-dot pattern screen stencil and a discharging agent having a viscosity of 8,000 mPa·s, which consists of 40 parts of sodium hypochlorite (12% effective chlorine), 12 parts of purified bentonite (BEN-GEL: HOJUN Co., Ltd.) as an inorganic thickener and 48 parts of water, and the resulting fabric was dried at 100° C. for 1 min and wet-heat treated by high-temperature atmospheric-pressure steam (HT steam) at 140° C. for 5 min for discharging the indigo dye.

As a result, because the strength to retain discharging agent of the inorganic thickener was weak, the polka-dot pattern bled and became blurry. In addition, although the first several number of fabrics could be printed, the printed parts became blurry and a irregularly-colored polka-dot pattern was obtained due to the extremely high thixotropy. Furthermore, the discharged parts were not as white as those in Example 1.

### COMPARATIVE EXAMPLE 4

A discharge printing treatment was performed in accordance with Example 2, except that the pH of the discharging agent used was adjusted to 4.0.

As a result, when the discharging agent was acidic, the sodium chlorite decomposed and the discharge printing of the denim fabric was unable to be achieved.

### COMPARATIVE EXAMPLE 5

A discharge printing treatment was performed in accordance with Example 2, except that the pH of the discharging agent used was adjusted to 13.0.

As a result, when the discharging agent was high alkaline, the thickener and synthetic resin emulsion were gelled, and the printing paste could not be produced.

### COMPARATIVE EXAMPLE 6

A denim dyed with an indigo dye was printed using a 80-mesh polka-dot pattern screen stencil and a printing paste, which consists of 60 parts of dextrin thickener, 10 parts of 85% sodium chlorite, 15 parts of 10% ammonium tartrate, 5 parts of kaolin clay and 10 parts of water, and the resulting fabric was dried at 70° C., then was subjected to a discharge printing treatment and rinsed with water to give a discharged fabric.

As a result, the obtained discharged fabric had a slightly inferior discharging characteristic with hard texture compared to Example 1; in addition, the dextrin thickener remained on the surface of the discharged fabric due to insufficient removal of the thickener.

### COMPARATIVE EXAMPLE 7

Color-discharge printing was performed using the discharging agent of Comparative example 6 to which 5 parts of an azo pigment (MATSUMIN Neo Color Red MFB: Matsui Shikiso Chemical Co., Ltd.) was added, in accordance with the process and condition of Comparative example 6.

As a result, the obtained color-discharge printed fabric had inferior discharging characteristic, with most of the red pigment removed during the water rinse process and the discharged parts contaminated, showing only purplish color.

Thereafter, 30 times of washing tests were performed in accordance with JIS L-0217 103, and the result showed extremely inferior washing fastness of the fabric, with the discharged parts showing only bluish color. In addition, in dry/wet rubbing tests in accordance with JISL-0849, extremely inferior rubbing fastness was obtained with very dirty appearance.

### INDUSTRIAL APPLICABILITY

Using the discharging agent of the invention, discharged fabrics having soft texture, bright coloration and contours with superior color fastness can be obtained from fabrics or sewing products dyed with an indigo dye and/or a sulfide dye.

1. A discharging agent for a fiber dyed with an indigo dye and/or a sulfide dye, consisting of chlorite and a viscosity-increasing nonionic surfactant.

2. A discharging agent according to claim 1, wherein the viscosity-increasing nonionic surfactant is a nonionic surfactant having HLB of 15 or higher.

3. A discharging agent according to claim 1, wherein the discharging agent contains a wetting agent.

4. A discharging agent according to claim 1, wherein the fiber is a fabric or a sewing product.

5. A discharge printing process, wherein when a fabric or a sewing product dyed with an indigo dye and/or a sulfide dye is subjected to a discharge printing treatment, a discharging agent having an adjusted pH of 7-12 and consisting of chlorite and a viscosity-increasing nonionic surfactant is printed on or applied to the fabric or the sewing product, followed by the application of a heat treatment.

6. A discharge printing process according to claim 5, wherein the discharge printing treatment is performed simultaneously with, before, or after a coloring treatment.

7. A discharge printing process according to claim 6, wherein the coloring treatment is performed using a colorant consisting of a pigment and a synthetic resin emulsion.

8. A discharge printing process according to claim 5, wherein the discharge printing treatment is to conduct rinsing with water and dechlorination after the discharge printing treatment.

9. A fabric or a sewing product dyed with an indigo dye and/or a sulfide dye, patterned by the discharge printing process according to claim 5.
